(19) United States
(12) Patent Application Publication
(10) Pub. No.: US 2023/0139643 A1
(43) Pub. Date: May 4, 2023

(54) Mechanical Rotating Spindle for Painting Designs

(71) Applicant: Lisa Forgione, Rockville Centre, NY (US)

(72) Inventor: Lisa Forgione, Rockville Centre, NY (US)

(21) Appl. No.: 17/517,876

(22) Filed: Nov. 3, 2021

(51) Int. Cl. B05C 13/02; B05C 1/02

(52) U.S. Cl. CPC B05C 13/025; B05C 1/02

(57) ABSTRACT

The present disclosure provides a portable apparatus with a long rotatable spindle covered with compressible gripping bristles. The long rotatable bristle covered spindle mounted within the apparatus is coupled and detachable coupled with a battery-operated motor. One or more rounded objects with central openings are mounted onto the rotatable spindle covered with compressible bristles that grip the round objects. The rounded objects will rotate at a desired speed to facilitate coating their exteriors evenly and efficiently.

### CROSS REFERENCES TO RELATED APPLICATIONS

The present application claims the benefit and priority of US provisional application no. U.S. 62/952,829, filed Dec. 23, 2019.

### FIELD OF INVENTION

The present invention relates generally to assistive apparatus for painting. More specifically, the present invention relates to a device upon which rounded objects such as beads may be mounted to facilitate even painting of their exterior.

### BACKGROUND

Devices such as painting and pottery wheels and lathes are well known in the art. They assist a user with artistic creation by rotating the media being worked on at a desired speed to allow an even coat/sculpt to be applied for rounded media. However, there is currently no such device available for mounting objects to be painted or otherwise marked such that an even coat can be applied to the entire outer surface.

Rounded objects such as beads are particularly inconvenient to paint manually in this manner, since they are small and in order for a user to hold them in place they must place their fingers over relatively large portions of the exterior surface. It thus becomes very difficult to apply an even coat to the entire exterior surface without touching the portions which are still wet.

There is a need for a device to allow a user to apply even coats of media to the exterior surfaces of such rounded objects without the need to touch them with their hands. It is within this context that the present invention is provided.

### SUMMARY

The present disclosure provides a portable apparatus which may be used to mount one or more rounded objects with central openings and cause them to rotate at a desired speed to facilitate coating their exteriors evenly and efficiently. The apparatus comprises a rotatable spindle mounted within a housing and detachable coupled to an electric motor, the spindle having one or more compressible elements along its length. The apparatus is particularly useful for painting objects such as beads without the need to touch them.

Thus, according to one aspect of the present disclosure there is provided an apparatus for mounting a rounded object, the apparatus comprising: a housing; a power source disposed within the housing; an electric motor disposed within the housing and coupled to the power source; one or more controls configured to control a power output of the electric motor; and a spindle comprising an elongated shaft configured to be threaded through an opening of one or more rounded objects, the spindle being detachably connected to the electric motor and positioned within the housing such that the spindle rotates freely within the housing when the electric motor is engaged.

In some embodiments, the spindle has one or more compressible elements disposed along its length for mounting rounded objects having openings of varying sizes.

Furthermore, the compressible elements may be radially disposed brush elements.

In some embodiments, the one or more controls comprise an on/off switch for coupling or de-coupling the electric motor from the power source.

In some embodiments, the one or more controls comprise a variable control knob for controlling a power output and thus a rotational speed of the electric motor, allowing a user to control the speed of rotation of the spindle. The control knob may for example be a potentiometer.

In some embodiments, the housing is an enclosure with a removable lid and one or more trays for catching material spilled during use.

In such embodiments, the one or more trays are removeable to facilitate cleaning in between uses.

The housing may also comprise a sealed compartment for protecting the power source and motor.

### BRIEF DESCRIPTION OF THE DRAWINGS

Various embodiments of the invention are disclosed in the following detailed description and accompanying drawings.

FIG. 1 illustrates an isometric view of an example configuration of the disclosed apparatus with the removable lid covering the housing.

FIG. 2 illustrates an isometric view of the same example configuration with the lid of the housing removed to expose the rotatable spindle enclosure.

FIG. 3 illustrates another isometric view of the same example configuration of the apparatus with portions of the housing removed to reveal the electric motor and power source, as well as the slidable tray of the housing.

FIG. 4 illustrates an isometric view of the core shaft of the rotatable spindle and the portion for coupling to the electric motor.

FIG. 5 illustrates a top down view of the example configuration of the apparatus with the electronic components covered by a sealed compartment.

FIG. 6 illustrates the same top down view with the lid of the sealed enclosure removed to expose the electronic components.

FIG. 7 illustrates a side-on view of the example configuration of the apparatus.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a portable device for assisting a user in painting even coats on or applying designs to rounded objects with central openings through which a rotatable spindle can be inserted.

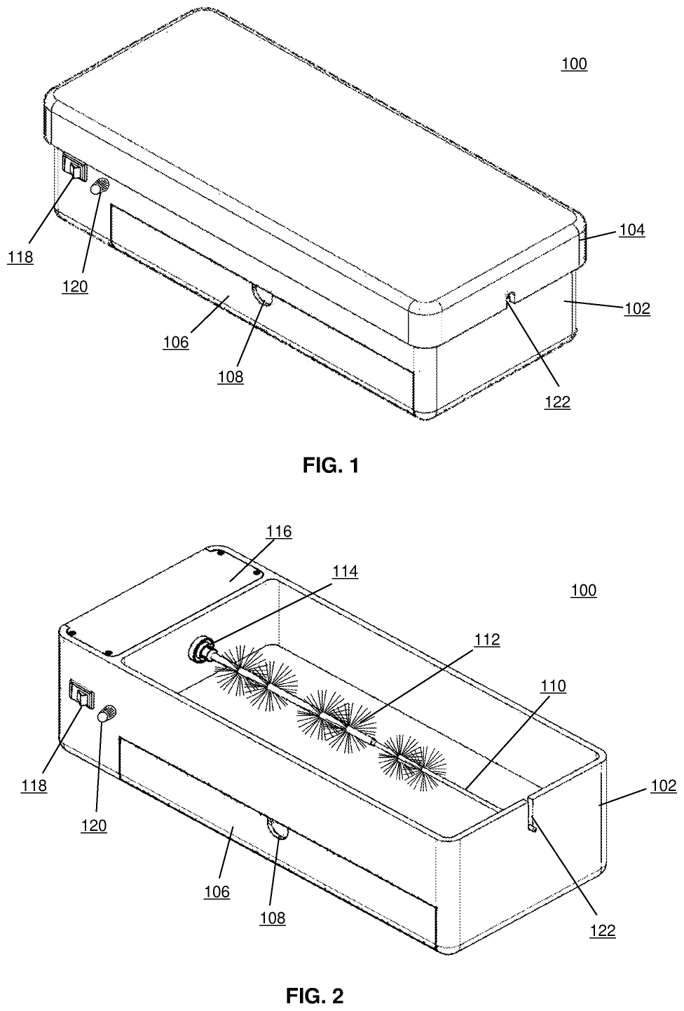

Referring to FIG. 1, an example configuration of the device 100 is shown. The example configuration is formed of an exterior housing 102 with a removable lid 104, forming an enclosure in which a rotatable spindle can be mounted as will be detailed below.

The housing 102 has disposed on the side a slidable tray 106 that is configured to catch falling paint and other media from artistic operations carried out using the device. The tray 106 can be removed by gripping the opening 108 and pulling it out, allowing a user to easily clean it in between uses.

It should be noted that while the housing is illustrated as a small box-like design in the example configuration, it can be of any suitable shape and size.

Referring to FIG. 2, the device is shown with the lid removed and the enclosure of the rotatable spindle exposed. The spindle is generally formed of an elongated shaft 110 with a plurality of compressible elements 112, in this case radially disposed brush elements, along its length. Rounded objects with central openings such as beads can be mounted on the spindle by inserting it through their central openings and over the compressible elements, which will then grip the objects and hold them in place while they are painted or marked. While radial brushes are used as an example, other types of compressible element may also be used.

The spindle should be detachable coupled to an electric motor of the device. In the present configuration, this is done by coupling 114. Coupling 114 may also allow the spindle to be rotate vertically upwards so that beads and other objects can be mounted thereon without removing it completely from the device. The opposing end of the spindle slots into a U-shaped opening 122 which it can freely rotate against.

In operation, a user would remove the lid from the device, lift the end of the spindle out of the U-shaped opening, mount one or more beads or other objects along the length of the spindle, and then replace the end in the U-shaped opening. They would then be able to use the exterior controls described below to cause the spindle to rotate at a desired speed and begin painting a coat or design on the mounted objects. Once finished, they would wait for the coatings to dry, lift the end of the spindle (or the entire spindle) out of the enclosure, and slide the painted objects off of it, never having to touch wet coating during the entire process.

The electric motor itself and the other electrical components of the device are disposed within a sealed enclosure covered by lid 116 which is screwed in place to prevent children or animals from accessing them.

The exterior sides of the housing have controls for moderating the power output of the electric motor. A binary on/off switch 118 controls the power supply to the electric motor and a variable control knob 120 in the form of a potentiometer can also be included to regulate the amount of power fed to the motor and thus the speed at which the connected spindle rotates.

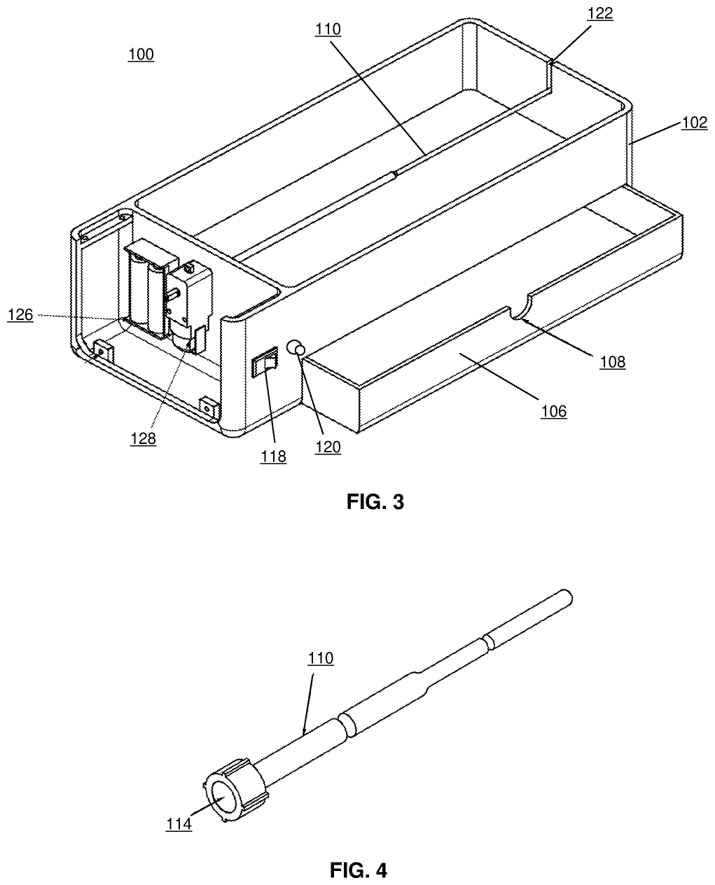

Referring to FIG. 3, the device 100 is shown with the lid 116 and a portion of the side wall removed so that the power source 126 and electric motor 128 are exposed. As can be seen, the rotational axis of the electric motor aligns with the rotational axis of the spindle to which it is coupled.

The power source in the present example is a set of removable AA batteries, but other power sources may also be used, such as for example rechargeable lithium polymer type batteries integrated into the device or even a power input that would connect to a USB or wall socket.

The tray 106 is also shown in a partially extended position. During use, paint and other media are likely to fall from the mounted objects on the spindle onto the tray, having the ability to remove it from the device entirely greatly simplifies the cleaning process.

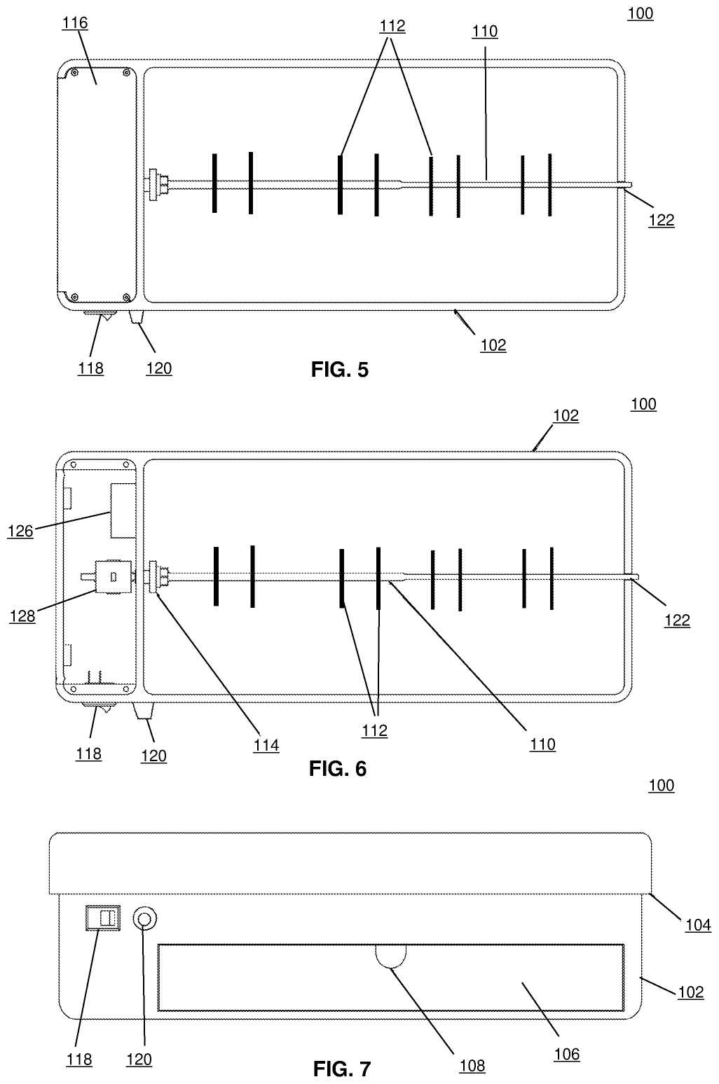

FIG. 4 shows the spindle shaft removed from the device and without the compressible elements along its length. FIGS. 5-7 show top down and side views of the device for additional clarity.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the device 100 have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. The apparatus for mounting a rotating spindle covered with compressible bristles so that the compressible bristles grip one or more rounded objects within the apparatus comprising:
a housing;
a power source disposed within the housing;
a battery-operated motor disposed within a structure and coupled to the power source;
one or more controls configured to control a power output of the battery operated motor; and
the compressible bristle covered spindle comprising an elongated shaft configured to be threaded through an opening of one or more rounded objects and therefore gripping the one or more rounded objects, the spindle covered with compressible bristles being detachably connected to the battery operated motor and positioned within the housing such that the spindle covered with compressible bristle rotates freely within the housing when the battery operated motor is engaged.

2. The apparatus according to claim 1, wherein the spindle has disposed compressible bristles along its length for gripping one or more rounded objects having openings of varying sizes.

3. The apparatus according to claim 2, wherein the compressible gripping bristle elements that grip one or more rounded objects having openings of various sizes are radially disposed.

4. The apparatus according to claim 1, wherein the control that comprises an on/off switch next to the variable control knob on the outside of the sealed compartment of the motor housing for coupling or decoupling the battery-operated motor from the power source.

5. The apparatus according to claim 1, wherein the control that comprises a variable control knob next to the on/off switch on the outside of the sealed compartment of the motor housing for controlling a power output and thus a rotational speed of the battery-operated motor, allowing a user to control the speed of rotation of the compressible bristle covered spindle.

6. The apparatus according to claim 5, wherein the control knob on the outside of the housing is a potentiometer.

7. The apparatus according to claim 1, wherein the housing is an enclosure with a lid and one or more trays for catching material spilled during use.

8. The apparatus according to claim 7, wherein the one or more trays are removeable to facilitate cleaning in between uses.

9. The apparatus according to claim 7, wherein the housing comprises a sealed compartment for protecting the power source and motor.
